(19) United States
(12) Patent Application Publication
(10) Pub. No.: US 2013/0139088 A1
(43) Pub. Date: May 30, 2013

(54) SYSTEM AND METHOD FOR MANAGING A MACHINING FILE USING A COMPUTING DEVICE

(71) Applicants: YUEH-HSUN KING, Tu-Cheng (TW); SHOU-MING LIANG, Tu-Cheng (TW)

(72) Inventors: YUEH-HSUN KING, Tu-Cheng (TW); SHOU-MING LIANG, Tu-Cheng (TW)

(73) Assignee: FOXNUM TECHNOLOGY CO., LTD., Tu-Cheng (TW)

(21) Appl. No.: 13/491,525

(22) Filed: Jun. 7, 2012

(30) Foreign Application Priority Data
Nov. 28, 2011 (TW) 100143485

(51) Int. Cl. G06F 3/048; G06F 17/30

(52) U.S. Cl. 715/771

(57) ABSTRACT

In a method for managing a machining file including a series of procedures in sequence using a computing device, names of the series of procedures are displayed in a procedure list area of the management page. If procedures require to be combined, the method receives user-selected procedures to be combined from a database area of the management page, and combines the selected procedures into a new procedure according to a predetermined combination format. If the machining file requires to be stored, the method stores all the procedures in the procedure list area into the machining file in sequence, and stores the machining file in a storage system of the computing device.

### BACKGROUND

1. Technical Field

Embodiments of the present disclosure relate to file management technology, and more particularly to a system and method for managing a machining file in a computing device.

2. Description of Related Art

There are two main methods for designing machining programs using computer numerical control (CNC) machine tools. The first method is programming the machining programs using special codes (e.g., Numerical control G codes and M codes in numerical machining). The second method provides a dialog window on a display for users to input machining dimensions and other parameters, which then generates a procedure according to the parameters and predetermined machining templates, and constitutes the machining programs including a series of the procedures. Both of the two types of methods have respective advantages. However, there is no relevant method has combination advantages of the two methods to manage the machining programs in a machining file efficiently and conveniently.

### BRIEF DESCRIPTION OF THE DRAWINGS

FIG. 1 is a block diagram of one embodiment of a computing device including a management system.

FIG. 2A and FIG. 2B are schematic diagrams of one embodiment of a user interface of the computing device of FIG. 1.

FIG. 3 is a block diagram of function modules of a management system included in the computing device of FIG. 1.

FIG. 4 is a flowchart of one embodiment of a method for managing machining file using the computing device of FIG. 1.

FIG. 5 is a schematic diagram of one embodiment of combining procedures in a machining file.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module” as used herein refers to logic embodied in hardware or firmware, or to a collection of software instructions, written in a programming language, such as, Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media include compact discs (CDs), digital versatile discs (DVDs), Blu-ray disks, flash memory, and hard disk drives.

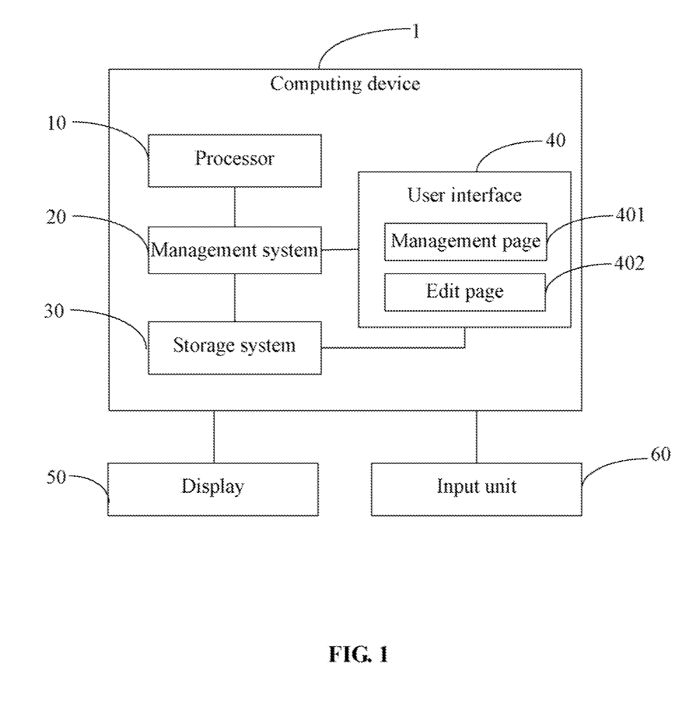

FIG. 1 is a block diagram of one embodiment of a computing device 1 including a management system 20. The computing device 1 further includes at least one processor 10, a storage system 30 and a user interface 40. The at least one processor 10 executes one or more computerized codes and other applications of the computing device 1, to provide functions of the management system 20. The storage system 30 stores different procedures (e.g. working procedures) and a plurality machining files. In one embodiment, a series of work procedures in a predetermined order for processing a workpiece using computer numerical control (CNC) machine tools constitute a machining file. The management system 20 may manage the procedures in the machining file through the user interface 40.

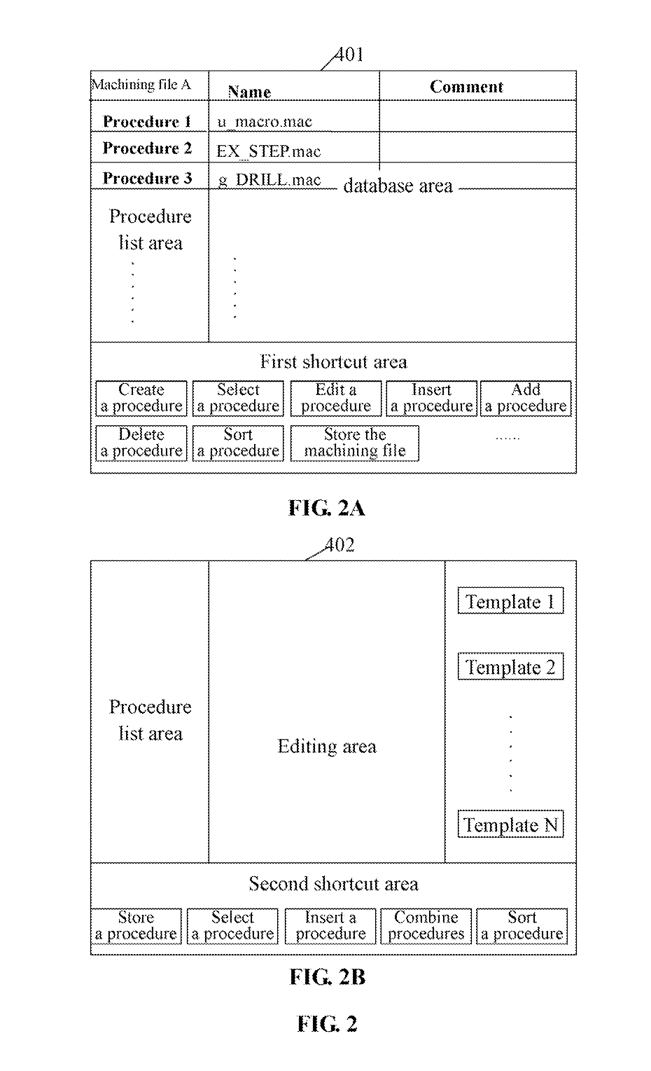

In one embodiment, each procedure has special codes (e.g. Numerical control G codes and M codes in numerical machining), and is stored in the storage system 30 according to a predetermined naming format. In some embodiments, the predetermined naming format may name user-defined procedures (written by user self) starting with “u_” (e.g., u_abc), name modified established procedures starting with “g_” (e.g., g_def), and name original established procedures starting with any other letter of an alphabet except “u_” and “g_” (e.g., a_ghi). The established procedures are fixed and custom-built procedures. As shown in FIG. 2A, a procedure having a name of “u_macro.mac” is the user-defined procedure, a procedure having a name of “EX_STEP.mac” is the original established procedure, and a procedure having a name of “g_DRILL.mac” is the modified established procedure.

The user interface 40, which is displayed on the display screen 50, provides display of a management page 401 and an editing page 402 as shown in FIG. 2A and FIG. 2B. The management page 401 displays the series of procedures in one machining file and the stored procedures in the storage system 30. The management page 401 includes a procedure list area, a database area, and a first shortcut area. The procedure list area includes a plurality of fields that displays the series of procedures in the machining file in sequence, such as, “procedure 1”, “procedure 2”, and “procedure 3” in a machining file “A” in FIG. 2A, for example. The database area displays names and comments (e.g. functions) of the stored procedures in the storage system 30. The first shortcut area displays a plurality of first shortcut keys corresponding to predetermined functions for managing the stored procedures or the series of procedures in the machining file.

The editing page 402 allows for user-editable deletion/additions to the stored procedures or the series of procedures in the machining file. The editing page 402 includes the procedure list area, an editing area, a template area, and a second shortcut area. The procedure list area also displays all the procedures in the machining file in sequence. The editing area displays one procedure to be edited by the user. The template area displays a plurality of templates of general procedures that are frequently-used. The user can click or select a shortcut (e.g. an icon) of one template for invoking the general procedure and insert the general procedure to a current editing position in the editing area. The second shortcut area also displays a plurality of second shortcut keys corresponding to predetermined functions for managing the stored procedures or the series of procedures in the machining file.

The computing device 1 may be connected an input unit 60. The input unit 60 may be a mouse and/or a keyboard used to click/press shortcut keys, select the stored procedures or the series of procedures or edit the selected procedures, for example.

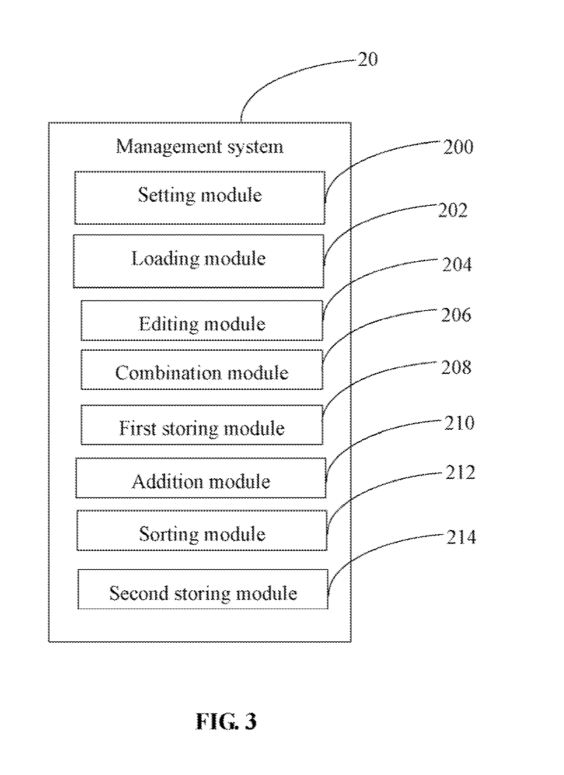

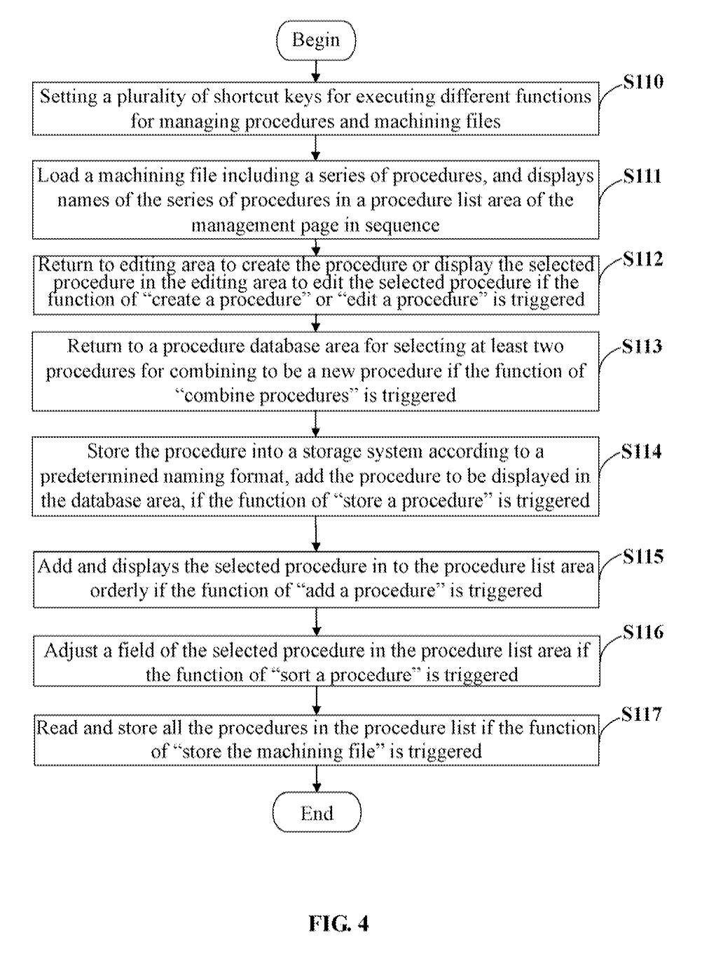

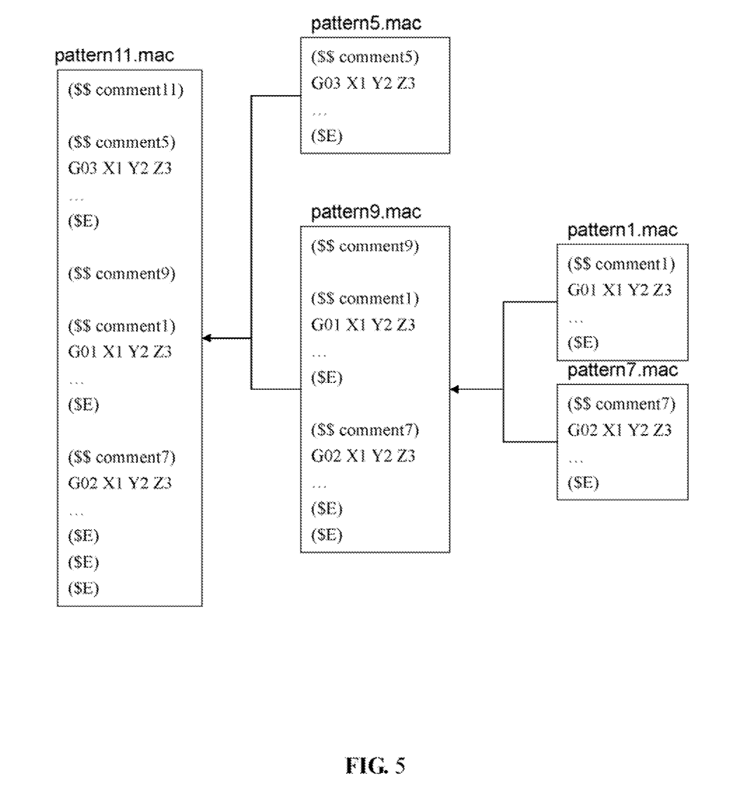

FIG. 3 is a block diagram of function modules of the management system 20 included in the computing device of FIG. 1. In the embodiment, the management system 20 may include a setting module 200, a loading module 202, an editing module 204, a combination module 206, a first storing module 208, an addition module 210, a sorting module 212, and a second storing module 214. The modules 200, 202, 204, 206, 208, 210, 212, and 214 comprise computerized codes in the form of one or more programs that are stored in the storage system 30. The computerized codes include instructions that are executed by the at least one processor 10 to provide functions for the modules. Details of each of the modules will be given in FIG. 4 and FIG. 5.

FIG. 4 is a flowchart of one embodiment of a method for managing machining files using the computing device of FIG. 1. Depending on the embodiment, additional steps may be added, others deleted, and the ordering of the steps may be changed.

In step S110, the setting module 200 sets a plurality of shortcut keys for executing different functions in the first and second shortcut areas. In one embodiment, the functions of the shortcut keys may include, but are not limited to creating, selecting, editing, inserting, adding, deleting, sorting, storing, or combining specific procedures, and storing the machining file. The specific procedures may be the stored procedures, or the series of procedures in the machining file, or new procedures created by user. If one of the shortcut keys is clicked or selected using the input unit 60, a corresponding function of the shortcut key is triggered to be executed. The plurality of shortcut keys may be shown as in FIG. 2A and FIG. 2B.

In step S111, the loading module 202 loads the machining file including a series of procedures from the storage system 30, and displays names of the series of procedures in the procedure list area in sequence on the display screen 50. In one embodiment, the series of procedures are displayed in the predetermined order under a name of the machining file, as shown in FIG. 2A, for example.

In step S112, if the function of “create a procedure” or the function of “edit a procedure” is triggered by selection of one or more of the shortcut keys, the editing module 204 displays the editing page 402 for the user to create the procedure in the editing area or display the selected procedure in the editing area for the user to edit the selected procedure. The user may create or edit the procedure by inserting templates of the general procedures in the template area into the editing area, and/or inputting codes in the editing area using the input unit 60, and/or inserting the stored procedure in the database area into the editing area according to triggering the function of “insert a procedure”.

In step S113, if the function of “combine procedures” is triggered by selection of one or more of the shortcut keys, the combination module 206 displays the management page 401 for prompting the user to select at least two stored procedures in the database area to be combined, and combines the selected procedures to be a new procedure according to a predetermined combination format. FIG. 5 is a schematic diagram of one embodiment of combining procedures according to the predetermined combination format. As shown in FIG. 5, machining programs of a procedure include “($$ comment#)”, machining codes and “($E)”. The “($$ comment#)” represents a start of a procedure, “comment#” is a note of the procedure, and the “($E)” represents an end of the procedure. One “($$ comment#)” is relative to one “($$ comment#)”. If a procedure named “pattern 1.mac” and a procedure named “pattern 7. mac” are selected to be combined to be a new procedure named “pattern 9.mac”, the combination module 206 starts the new procedure with “($$ comment9)”, and adds machining programs of the “pattern 1. mac” and the “pattern 7. mac” as the machining codes of the new procedure, and ends the new procedure with “($E)”. As shown in FIG. 5, if a procedure named “pattern 5.mac” and a “pattern 9. mac” are selected to combine to be a new procedure named “pattern 11. mac”, machining programs of the new procedure include a start of “($$ comment11)”, machining programs of the “pattern 5. mac” and “pattern 9. mac”, and an end of “($E)” in sequence.

In step S114, if the function of “store a procedure” (including the created or edited or combined procedure) is triggered by selection of one or more of the shortcut keys, the first storing module 208 stores the procedure into the storage system 30 according to the predetermined naming format, adds the procedure to be displayed in the database area. In one embodiment, if a user-defined procedure is edited, the starting of “u_” in the name of the user-defined procedure is remained. If an original established procedure is edited, the name of the original established procedure is added the starting of “g_”. If a modified established procedure is edited, the starting of “g_” in the name of the procedure is remained. The name of the created procedure or the combined procedure is added the starting of “u_”.

In step S115, if the function of “add a procedure” is triggered by selection of one or more of the shortcut keys, the addition module 210 adds and displays the selected procedure orderly into the procedure list area. In one embodiment, if the function of “deleting a procedure” is triggered by selection of one or more of the shortcut keys, the addition module 210 deletes the selected procedure from the procedure list area, and adjusts sequences of the fields of the procedures after the deleted procedure in the procedure list area in sequence.

In step S116, if the function of “sort a procedure” is triggered by selection of one or more of the shortcut keys, the sorting module 212 adjusts a sequence of a field of the selected procedure in the procedure list area according to an upward key or a downward key of the input unit 60.

In step S117, if the function of “store the machining file” is triggered by selection of one or more of the shortcut keys, the second storing module 214 stores all the procedures displayed in the procedure list area into the machining file in sequence. In one embodiment, the second storing module 214 may store the machining file to be a new machining file in the storage system 30, or to overwrite the original machining file in the storage system 30.

It should be noted that, the above-mentioned steps S112-S117 may be executed in other orders different from FIG. 4. The user can combine and edit the selected procedures randomly for managing the procedures in the machining file according to user requirements.

All of the processes described above may be embodied in, and be fully automated via, functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for managing a machining file comprising a series of work procedures, using a computing device electronically connected to a display that displays a user interface, the user interface displaying a management page and an editing page, the method comprising:
displaying names of the series of procedures in a procedure list area of the management page;
receiving user-selected procedures to be combined from a database area of the management page, and combining the selected procedures into a new procedure according to a predetermined combination format;
adding and displaying a selected procedure into the procedure list area orderly; and
storing all the procedures displayed in the procedure list area into the machining file, and storing the machining file into a storage system of the computing device.

2. The method according to claim 1, further comprising:
setting a plurality of shortcut keys for executing different functions in shortcut areas of both the management page and the editing page, the different functions of the shortcut keys comprising creating or selecting the procedure, inserting, editing, adding, deleting, sorting, or storing the selected procedure, combining the selected procedures, and storing the machining file.

3. The method according to claim 2, further comprising:
displaying the editing page in response to user-selection of the function of creating the procedure or displaying the selected procedure in the editing area in response to user-selection of the function of editing the selected procedure, and creating the procedure or editing the selected procedure by inserting templates of general procedures in a template area of the editing page into the editing area, the general procedures being frequently-used; and/or
inputting codes in the editing area using an input unit of the computing device; and/or
inserting stored procedures in the database area into the editing area.

4. The method according to claim 2, further comprising:
storing the created or edited or combined procedure into the storage system according to a predetermined naming format, and adding the created or edited or combined procedure to be displayed in the database area;
adjusting a sequence of a field of the selected procedure in the procedure list area according to an upward key or a downward key of the input unit.

5. The method according to claim 1, wherein the predetermined naming format of the stored procedures in the database area comprises user-defined procedures being named starting with “u_”, modified established procedures being named starting with “g_”, and original established procedures being named starting with a random letter except the “u_” and “g_”, the established procedures being fixed and custom-built procedures.

6. The method according to claim 1, wherein the predetermined combination format of combing the selected procedures into the new procedure comprises starting the new procedure with “($$ comment#)” according to a name of the new procedure, adding machining programs of the selected procedures after the “($$ comment#)”, and ending the new procedure with “($E)”.

7. A non-transitory storage medium storing a set of instructions, when executed by at least one processor of a computing device, cause the at least one processor to perform a method for managing a machining file comprising a series of work procedures, using the computing device electronically connected to a display that displays a user interface, the user interface displaying a management page and an editing page, the method comprising:
displaying names of the series of procedures in a procedure list area of the management page;
receiving user-selected procedures to be combined from a database area of the management page, and combining the selected procedures into a new procedure according to a predetermined combination format;
adding and displaying a selected procedure into the procedure list area orderly; and
storing all the procedures displayed in the procedure list area into the machining file, and storing the machining file into a storage system of the computing device.

8. The non-transitory storage medium according to claim 7, further comprising:
setting a plurality of shortcut keys for executing different functions in shortcut areas of both the management page and the editing page, the different functions of the shortcut keys comprising creating or selecting the procedure, inserting, editing, adding, deleting, sorting, or storing the selected procedure, combining the selected procedures, and storing the machining file.

9. The non-transitory storage medium according to claim 8, further comprising:
displaying the editing page in response to user-selection of the function of creating the procedure or displaying the selected procedure in the editing area in response to user-selection of the function of editing the selected procedure, and creating the procedure or editing the selected procedure by inserting templates of general procedures in a template area of the editing page into the editing area, the general procedures being frequently-used; and/or
inputting codes in the editing area using an input unit of the computing device; and/or
inserting stored procedures in the database area into the editing area.

10. The non-transitory storage medium according to claim 8, further comprising:
storing the created or edited or combined procedure into the storage system according to a predetermined naming format, and adding the created or edited or combined procedure to be displayed in the database area;
adjusting a sequence of a field of the selected procedure in the procedure list area according to an upward key or a downward key of the input unit.

11. The non-transitory storage medium according to claim 7, wherein the predetermined naming format of the stored procedures in the database area comprises user-defined procedures being named starting with “u_”, modified established procedures being named starting with “g_”, and original established procedures being named starting with a random letter except the “u_” and “g_”, the established procedures being fixed and custom-built procedures.

12. The non-transitory storage medium according to claim 7, wherein the predetermined combination format of combing the selected procedures into the new procedure comprises starting the new procedure with “($$ comment#)” according to a name of the new procedure, adding machining programs of the selected procedures after the “($$ comment#)”, and ending the new procedure with “($E)”.

13. A computing device, comprising:
a display displaying a user interface, the user interface displaying a management page and an editing page;
a storage system;
at least one processor; and
one or more programs that are stored in the storage system and executed by the at least one processor, the one or more programs comprising:
a loading module that loads a machining file comprising a series of procedures from the storage system, and displays names of the series of procedures in a procedure list area of the management page;
a combination module that receives user-selected procedures to be combined from a database area of the management page, and combines the selected procedures into a new procedure according to a predetermined combination format;
an addition module that adds and displays a selected procedure into the procedure list area orderly; and
a second storing module that stores all the procedures displayed in the procedure list area into the machining file, and stores the machining file into the storage system.

14. The computing device according to claim 13, wherein the one or more programs further comprises:
a setting module that sets a plurality of shortcut keys for executing different functions in shortcut areas of both the management page and the editing page, the different functions of the shortcut keys comprising creating or selecting the procedure, inserting, editing, adding, deleting, sorting, or storing a selected procedure, combining the selected procedures, and storing the machining file.

15. The computing device according to claim 14, wherein the one or more programs further comprises a displaying module that displays the editing page in response to user-selection of the function of creating the procedure or displays the selected procedure in the editing area in response to user-selection of the function of editing the selected procedure, and creating the procedure or editing the selected procedure by inserting templates of general procedures in a template area of the editing page into the editing area, the general procedures being frequently-used; and/or
inputting codes in the editing area using an input unit of the computing device; and/or
inserting stored procedures in the database area into the editing area.

16. The computing device according to claim 14, wherein the one or more programs further comprises:
a first storing module that stores the created or edited or combined procedure into the storage system according to a predetermined naming format, and adds the created or edited or combined procedure to be displayed in the database area;
a sorting module that adjusts a sequence of a field of the selected procedure in the procedure list area according to an upward key or a downward key of the input unit.

17. The computing device according to claim 13, wherein the predetermined naming format of the stored procedures in the database area comprises user-defined procedures being named starting with “u_”, modified established procedures being named starting with “g_”, and original established procedures being named starting with a random letter except the “u_” and “g_”, the established procedures being fixed and custom-built procedures.

18. The computing device according to claim 13, wherein the predetermined combination format of combing the selected procedures into the new procedure comprises starting the new procedure with “($$ comment#)” according to a name of the new procedure, adding machining programs of the selected procedures after the “($$ comment#)”, and ending the new procedure with “($E)”.
